(19) United States
(12) Patent Application Publication
(10) Pub. No.: US 2024/0337384 A1
(43) Pub. Date: Oct. 10, 2024

(54) Particulate Distributor for Coal Supply Conduit

(71) Applicant: SAS GLOBAL CORPORATION, Warren, MI (US)

(72) Inventors: David Allen Billings, JR., Garden City, MI (US); Justin James-Paul Bennett, Novi, MI (US); Kevin Raymond Kleist, Macomb, MI (US)

(21) Appl. No.: 18/296,773

(22) Filed: Apr. 6, 2023

(51) Int. Cl. F23K 3/02

(52) U.S. Cl. CPC F23K 3/02; F23K 2203/201

(57) ABSTRACT

A particulate distributor for pulverized coal flowing to a combustion chamber has an inner cylinder, an outer cylinder concentric with the inner cylinder, an intermediate cylinder concentric with the inner cylinder, a first flow channel defined between the inner cylinder and the intermediate cylinder, the first flow channel having a first cross-sectional flow area, a second flow channel defined between the intermediate cylinder and the outer cylinder, the second flow channel having a second cross-sectional flow area, and an outlet diffuser attached to an outlet side of the particulate distributor, the outlet diffuser having a surface area extending perpendicular to the first flow channel and the second flow channel. The outlet diffuser is configured to reduce the first cross-sectional flow area and the second cross-sectional flow area at the outlet side.

### TECHNICAL FIELD

This disclosure relates to a dual-phase particulate distributor for a coal supply conduit supplying coal to a combustion chamber of a coal-fired boiler.

### BACKGROUND

Combustion chambers for turbine generator boilers, for example, as red with airborne particulate coal. The coal is fed through a pulverizer/classifier through a supply conduit. Often, the supply conduit is divided into several branches feeing into spaced points around the combustion chamber. The branches should exhibit approximately equal coal flow rates to stability the fireball in the combustion chamber. Non-uniform flow of particulate coal, as well as non-homogeneous particle size and distribution of the particulate coal, is problematic.

### SUMMARY

Disclosed herein are implementations of a particulate distributor for pulverized coal flowing to a combustion chamber. The implementations disclosed herein provide improved mixing designs in a single unit, promoting improved diffusion action within a more defined and compact area. The implementations induce additional impact of the air/particle mixture with parts of the distributor to improve particle pulverization and distribution, accelerating a homogenous mixture of air and fuel while maximizing the mixing and distribution in a single, ideal location or plane. The implementations provide a single unit that improves installation and maintenance, making them easier to perform and safer.

One implementation of a particulate distributor for pulverized coal flowing to a combustion chamber has an inner cylinder, an outer cylinder concentric with the inner cylinder, an intermediate cylinder concentric with the inner cylinder, a first flow channel defined between the inner cylinder and the intermediate cylinder, the first flow channel having a first cross-sectional flow area, a second flow channel defined between the intermediate cylinder and the outer cylinder, the second flow channel having a second cross-sectional flow area, and an outlet diffuser attached to an outlet side of the particulate distributor, the outlet diffuser having a surface area extending perpendicular to the first flow channel and the second flow channel. The outlet diffuser is configured to reduce the first cross-sectional flow area and the second cross-sectional flow area at the outlet side.

Another implementation of a particulate distributor for pulverized coal flowing to a combustion chamber has an inner cylinder, an outer cylinder concentric with the inner cylinder, an intermediate cylinder concentric with the inner cylinder, a first flow channel defined between the inner cylinder and the intermediate cylinder, the first flow channel having first vanes each extending between and attached to the inner cylinder and the intermediate cylinder to divide the first flow channel into first flow subdivisions, a second flow channel defined between the intermediate cylinder and the outer cylinder, the second flow channel having second vanes each extending between and attached to the outer cylinder and the intermediate cylinder to divide the second flow channel into second flow subdivisions, and an outlet diffuser attached to an outlet side of the particulate distributor, the outlet diffuser configured to reduce a cross-sectional area of each of the first flow subdivisions and the second flow subdivisions at the outlet side.

Another implementation of a particulate distributor for pulverized coal flowing to a combustion chamber has an inner cylinder, an outer cylinder concentric with the inner cylinder, an intermediate cylinder concentric with the inner cylinder, a first flow channel defined between the inner cylinder and the intermediate cylinder, the first flow channel having first vanes each extending between and attached to the inner cylinder and the intermediate cylinder, a second flow channel defined between the intermediate cylinder and the outer cylinder, the second flow channel having second vanes each extending between and attached to the outer cylinder and the intermediate cylinder, and an outlet diffuser attached at an outlet side of the particulate distributor. The outlet diffuser can have a number of members, each member aligned with an outlet edge of a respective first vane or a respective second vane, The outlet diffuser can have opposed longitudinal edges having teeth formed in therein, the teeth extending into one of the first flow channel or the second flow channel and forming an impingement surface configured to reduce a cross-sectional area of each of the first flow channel and the second flow channel.

Other applications of the disclosed implementations will become apparent to those skilled in the art when the following description is read in conjunction with the accompanying drawings.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is diagram of a system for supplying pulverized and classified airborne particulate coat to a combustion chamber.

FIG. 2 is an enlarged cross-section through the outlet supply conduit and particulate distributor.

FIG. 3 is a perspective view of an implementation of a particulate distributor as disclosed herein.

FIG. 4 is a side view of the implementation of the particulate distributor of FIG. 3.

FIG. 5 is a plan view of an inlet side of the implementation of the particulate distributor of FIG. 3.

FIG. 6 is a plan view of an outlet side of the implementation of the particulate distributor of FIG. 3.

FIG. 7 is a perspective view of another implementation of a particulate distributor as disclosed herein.

FIG. 8 is a side view of the implementation of the particulate distributor of FIG. 7.

FIGS. 9-12 are plan views of varying implementations of members of an outlet diffuser as disclosed herein.

FIG. 13 is a cutaway of an implementation of a particulate distributor with the outlet diffuser removed for view of the vanes.

### DETAILED DESCRIPTION

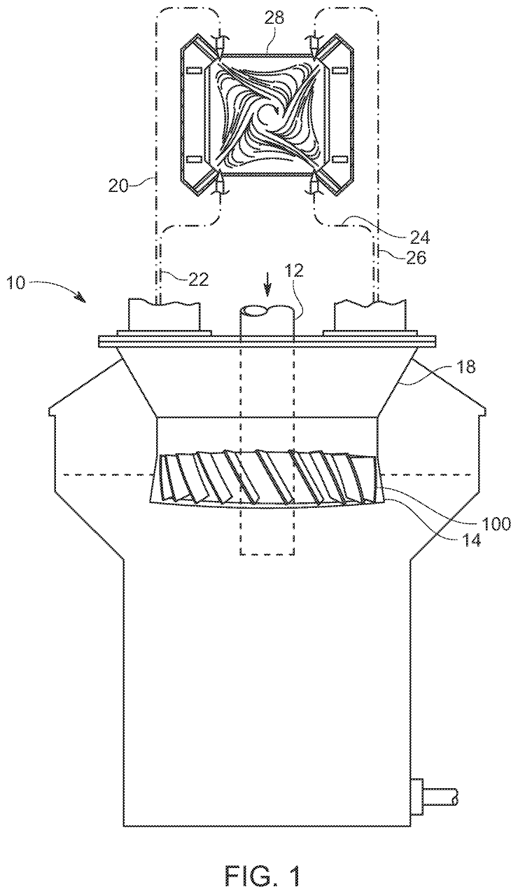

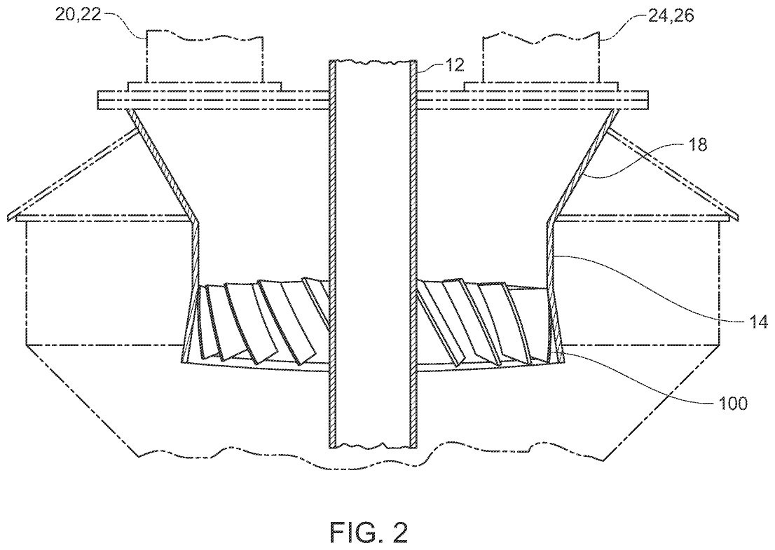

Referring to FIGS. 1 and 2, a conventional coal pulverizer/classifier 10 has a coal inlet supply conduit 12 centrally and vertically positioned for feeding lump coal into the pulverizer/classifier 10 in controlled quantities. The pulverizer/classifier 10 has a main outlet supply conduit 14 which, in the illustrated coal pulverizer/classifier 10, is concentric with the coal inlet supply conduit 12 but substantially larger in diameter. Some pulverizers/classifiers may have side feed features in which case the coal inlet supply conduit 12 may serve as a center outflow channel with or without vanes. Alternatively, with a side feed feature, the coal inlet supply conduit 12 is non-existent or blocked off. The outlet supply conduit 14 merges into a frustoconical transition section 18 which acts as a manifold to supply airborne particulate coal to four parallel branch conduits 20, 22, 24, 26 which may be arranged as illustrated to supply the four corners of a combustion chamber 28 which is associated with a boiler for supplying steam to the turbine of an electrical power generator, for example. The transition section 18 may alternatively be straight-sided, i.e., substantially cylindrical. Four branch conduits are illustrated, but the number may vary. In operation, lump coal is gravity fed through the coal inlet supply conduit 12 to the pulverizer/classifier 10 which operates in a conventional fashion. Pulverized coal is carried upwardly in an air stream through the outlet supply conduit 14 before entering the four parallel branch conduits 20, 22, 24 and 26, which in turn supply the four corners of the combustion chamber 28 or “firebox” of the turbine boiler.

Mechanically pulverizing coal into a powder enables it to be burned more efficiently. The coal particles are entrained in air. Because the pulverized coal has more surface area per unit weight than larger coal particles, more surface area is exposed to heat and oxygen. The combustion reaction occurs at a faster rate, requiring less air for complete combustion. An increasing demand for higher efficiency always exists, and improvements to the distribution and homogeneousness of the coal particulate can help to meet the demand.

Disclosed herein are implementations of a particulate distributor for use in the outlet supply conduit 14 of pulverizer/classifiers 10. The particulate distributor provides a combination of mixing designs into a single unit to promote improved diffusion action within a more defined and compact area of the outlet supply conduit 14. The particulate distributor induces additional impact of the air/particle mixture with parts of the distributor to improve particle pulverization and distribution, accelerating a homogenous mixture of air and fuel while maximizing the mixing and distribution in a single, ideal location or plane inside the outlet supply conduit 14. Containing the blending of the coal and air to a single, lower location can prevent disturbances caused by isolation swing valves.

In addition to the improvements in particle distribution and homogenous air/particulate mixtures, the particulate distributors disclosed herein provide a combination of mixers/distributors in a single unit that improves installation and maintenance, making them easier to perform and safer. The conical shape of some the disclosed particulate distributors allows for maintenance access on mill isolation components. Further, the conical shape lowers the differential pressure across the distributor and improves flow of the air/coal particulate stream.

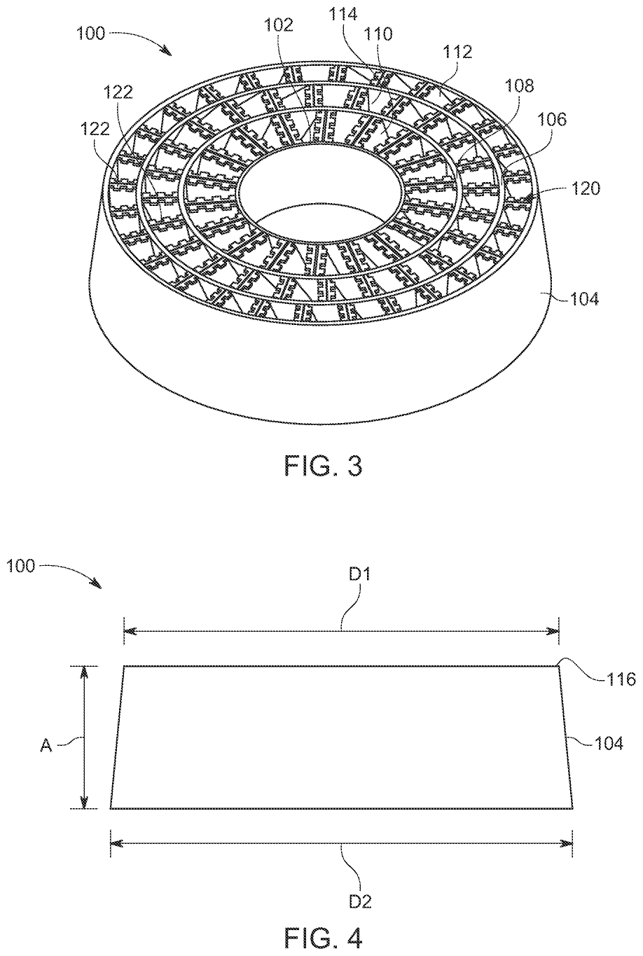

An implementation of a particulate distributor 100 is illustrated in FIGS. 3-6. The particulate distributor 100 is mounted in the outlet supply conduit 14 of the pulverizer/classifier 10 with flanges or other mechanical assemblies known to those skilled in the art. The mountings should not obstruct the flow of the air/coal particulate mixture.

The particulate distributor 100 has an inner cylinder 102, an outer cylinder 104 concentric with the inner cylinder 102, and an intermediate cylinder 106 concentric with both the inner cylinder 102 and the outer cylinder 104. There can be more than one intermediate cylinder 106. As illustrated in the figures, there are two intermediate cylinders, intermediate cylinder 106 and intermediate cylinder 108. A first flow channel 110 is defined between the inner cylinder 102 and the intermediate cylinder 108, the first flow channel 110 having a first cross-sectional flow area. A second flow channel 112 is defined between the intermediate cylinder 106 and the outer cylinder 104, the second flow channel 112 having a second cross-sectional flow area. In certain implementations with only one intermediate wall, there will be only two flow channels. As illustrated, there is a third flow channel 114 having a third cross-sectional flow area between intermediate cylinders 106 and 108. The cross-sectional areas of each flow section may be configured to be equal, or may be configured to be different.

The inner cylinder 102 is sized to friction fit around the coal inlet supply conduit 12. The outer cylinder 104 has an inlet diameter D₂ and an outlet diameter D₁, the inlet diameter D₂ being greater than the outlet diameter D₁. The outer cylinder 104 can gradually slope between the different diameters as illustrated in FIGS. 3-6, forming a conical shape. The conical shape allows for maintenance access on mill isolation components. Further, the conical shape lowers the differential pressure across the distributor and improves flow of the air/coal particulate stream. As shown in FIGS. 1 and 2, the outlet supply conduit 14 can also be shaped such that the outer cylinder 104 is in contact with the outlet supply conduit 14 across its entire outer wall. Alternatively, the outlet supply conduit 14 may be vertical, with an inner diameter that allows the inlet diameter D₂ of the outer wall to just fit within the outlet supply conduit 14.

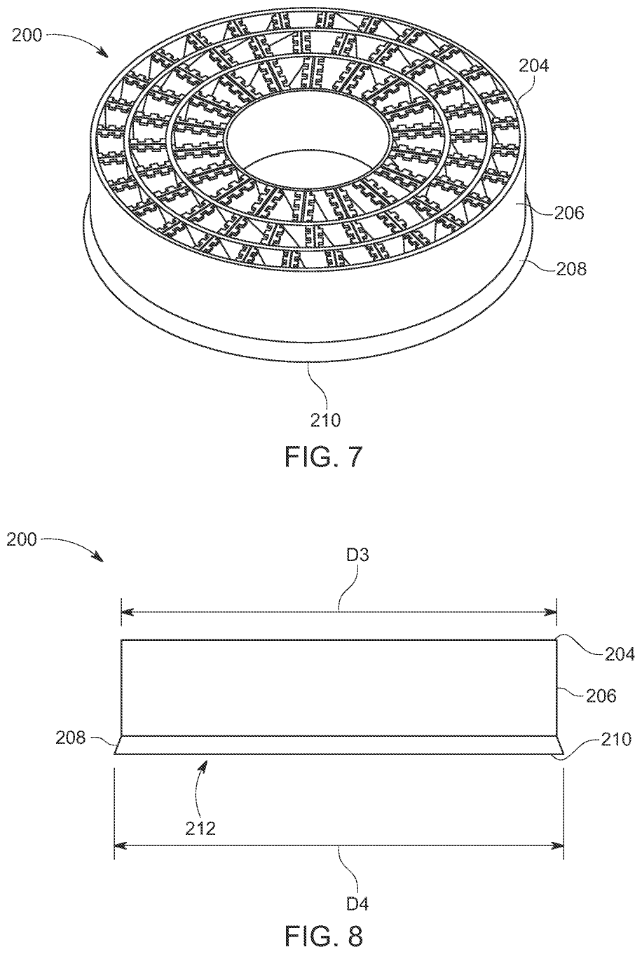

Alternatively, as illustrated in FIGS. 7 and 8, a particulate distributor 200 may have an outer cylinder 204 with a vertical portion 206 having a first diameter D₃ and a flared portion 208 extending from the vertical portion 206 and having a second diameter D₄ at a distal end 210 of the flared portion 208, the second diameter Da greater than the first diameter D₃ and positioned at an inlet side 212 of the particulate distributor 200.

The particulate distributor 100 has an outlet diffuser 120 attached to an outlet side 116 of the particulate distributor 100, the outlet diffuser 120 having a surface area extending perpendicular to a longitudinal axis A of the particulate distributor 100, the surface area extending into one or more of the first flow channel 110, the second flow channel, and the third flow channel 114. The outlet diffuser 120 is configured to reduce the cross-sectional flow area of a flow channel at the outlet side 116.

The outlet diffuser 120 can have members 122 extending radially at least partway between the inner cylinder 102 and the outer cylinder 104. The members 122 are similar to slats, planks or elongated plates of material, as non-limiting examples. The members 122 can span a distance between the inner cylinder 102 and the outer cylinder 104 or can span distances between inner cylinder 102 and one of intermediate cylinder 106 or 108, distances between the outer cylinder 104 and one of intermediate cylinder 106 or 108, or a distance between intermediate cylinders 106 and 108. Each member 122 has opposed longitudinal edges 124 with at least one longitudinal edge having teeth 126 formed therein.

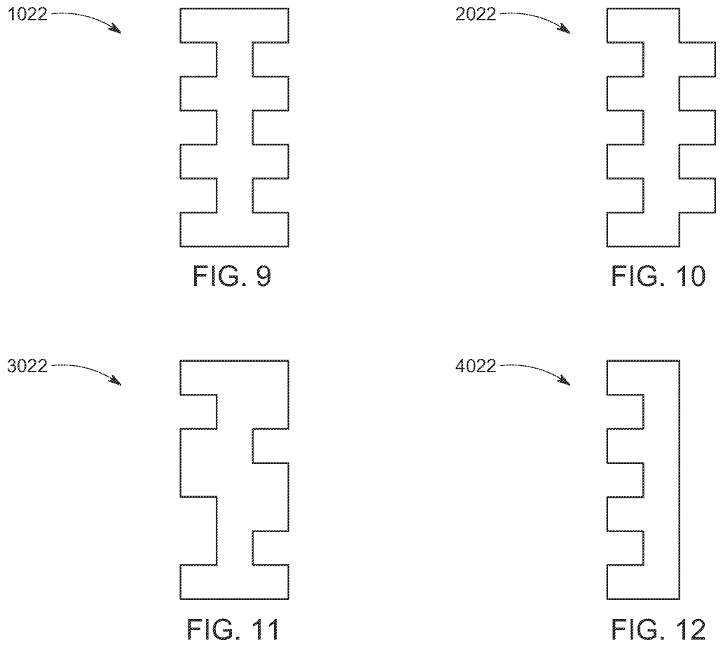

As noted, the outlet diffuser 120 is configured to reduce the cross-sectional flow area of each flow channel by providing surface area which obstructs the flow channel, the particulate coal dispersed in air impinging on the outlet diffuser 120 resulting in better mixing, dispersion and particulate size. The actual shape of the members 122 of the outlet diffuser 120 is not limited to that shown in FIGS. 3-6. FIGS. 9-12 provide further examples of double sided members 1022, 2022 and 3022 and a one sided member 4022, respectively, with teeth of varying number and size. It is noted that the teeth should be of a size that can withstand the force of the impact on them from the entrained coal particles and of a size to provide sufficient area to encourage impingement while not restricting the flow through the channels to a negative degree.

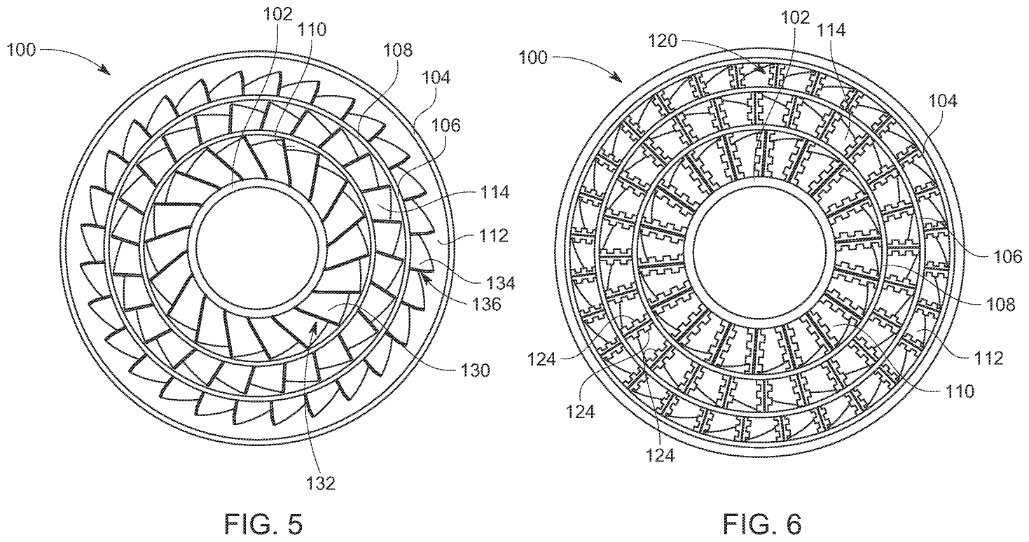

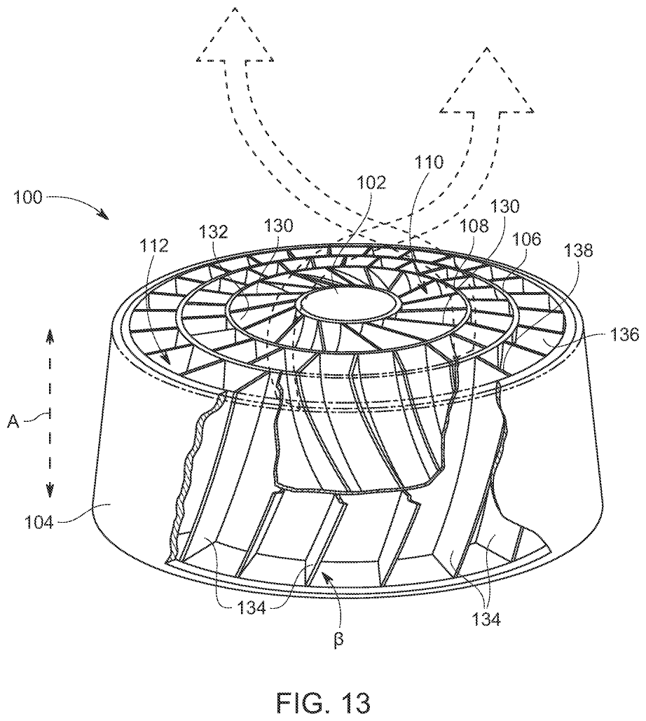

As illustrated in FIGS. 5 and 13, the first flow channel 110 can have first vanes 130 each extending between and attached to the inner cylinder 102 and the intermediate cylinder 108. There may be any number of first vanes 130. The first vanes 130 divide the first flow channel 110 into first flow subdivisions 132. The first flow subdivisions 132 can be of equal areas as illustrated for can be divided so as to be varying areas. The second flow channel 112 can have second vanes 134 each extending between and attached to the outer cylinder 104 and the intermediate cylinder 106. The second vanes 134 divide the second flow channel 112 into second flow subdivisions 136. The second flow subdivisions 136 can be of equal areas as illustrated for can be divided so as to be varying areas. Any intermediate flow channel, such as third flow channel 114, can also have vanes dividing the flow channel into flow subdivisions. The first vanes 130 and second vanes 134 can be configured vertically or at an angle. For example, as seen in FIG. 13, the first vanes 130 may be oriented to form a first angle with the longitudinal axis A of the particulate distributor 100 to direct flow in a first direction and the second vanes 134 may be oriented to form a second angle β with the longitudinal axis A of the particulate distributor 100 to direct flow in a second direction. FIG. 13 is showing the particulate distributor 100 without the outlet diffuser 120 for clarity.

The outlet diffuser 120 can be attached to one or more first vanes 130 and one or more second vanes 134 at an outlet edge 138 of the one or more first vanes 130 and the one or more second vanes 134. The outlet diffuser 120 may have a member 122 associated with each vane in each flow channel such that a total number of vanes equals a total number of members 122, may have a member 122 associated with each vane in only one or less than all of the flow channels, may have a member 122 associated with only a portion of the vanes in each of the flow channels, or may have a member 122 associated with only a portion of vanes in one or less than all of the flow channels. All members 122 may have teeth 126 on both longitudinal edges 124 extending in both adjacent flow subdivisions. All members 122 may have teeth 126 on only one longitudinal edge 124 extending into only one adjacent flow subdivision. Members 122 may have a combination of teeth 126 on both longitudinal edges 124 and teeth 126 on only one longitudinal edge 124. All teeth 126 may be of the same shape and size or may be all of the same size but varying shape or may be all of the same shape and varying size. The outlet diffuser 120 may reduce cross-sectional flow areas of the flow channels each by equal amounts or by different amounts. As illustrated in the figures, an implementation of the outlet diffuser 120 has members 122 extending radially along an entire distance between the inner cylinder 102 and the intermediate cylinder 106, members 122 extending radially along an entire distance between intermediate cylinder 106 and intermediate cylinder 108, and members 122 extending radially along an entire distance between intermediate cylinder 108 and outer cylinder 104. The outlet diffuser 120 has a member 122 associated with each vane in each of the first flow channel 110, the second flow channel 112 and the third flow channel 114. Each member 120 has teeth 126 alone each longitudinal edge 124.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A particulate distributor for pulverized coal flowing to a combustion chamber, the particulate distributor comprising:
an inner cylinder;
an outer cylinder concentric with the inner cylinder;
an intermediate cylinder concentric with the inner cylinder;
a first flow channel defined between the inner cylinder and the intermediate cylinder, the first flow channel having a first cross-sectional flow area;
a second flow channel defined between the intermediate cylinder and the outer cylinder, the second flow channel having a second cross-sectional flow area; and
an outlet diffuser attached to an outlet side of the particulate distributor, the outlet diffuser having a surface area extending perpendicular to a longitudinal axis of the particulate distributor, the outlet diffuser configured to reduce the first cross-sectional flow area and the second cross-sectional flow area at the outlet side.

2. The particulate distributor of claim 1, wherein:
the first flow channel has first vanes each extending between and attached to the inner cylinder and the intermediate cylinder, the first vanes oriented to form a first angle with a longitudinal axis of the particulate distributor to direct flow in a first direction;
the second flow channel has second vanes each extending between and attached to the outer cylinder and the intermediate cylinder, the second vanes oriented to form a second angle with the longitudinal axis of the particulate distributor to direct flow in a second direction; and
the outlet diffuser is attached to one or more first vanes and one or more second vanes at an outlet edge of the one or more first vanes and the one or more second vanes.

3. The particulate distributor of claim 2, wherein the outlet diffuser is attached to each of the first vanes and each of the second vanes, the outlet diffuser reducing the first cross-sectional flow area and the second cross-sectional flow area by equal amounts.

4. The particulate distributor of claim 2, wherein the outlet diffuser comprises members each extending along the outlet edge of a respective vane, the members having opposed longitudinal edges with at least one longitudinal edge having teeth formed therein.

5. The particulate distributor of claim 1, wherein the outlet diffuser comprises members extending radially at least partway between the inner cylinder and the outer cylinder, the members having opposed longitudinal edges with at least one longitudinal edge having teeth formed therein.

6. The particulate distributor of claim 1, wherein the outer cylinder has an inlet diameter and an outlet diameter, the inlet diameter being greater than the outlet diameter.

7. The particulate distributor of claim 1, wherein the outer cylinder has a vertical portion having a first diameter and a flared portion extending from the vertical portion and having a second diameter at a distal end of the flared portion, the second diameter greater than the first diameter and positioned at an inlet side of the particulate distributor.

8. A particulate distributor for pulverized coal flowing to a combustion chamber, the particulate distributor comprising:
an inner cylinder;
an outer cylinder concentric with the inner cylinder;
an intermediate cylinder concentric with the inner cylinder;
a first flow channel defined between the inner cylinder and the intermediate cylinder, the first flow channel having first vanes each extending between and attached to the inner cylinder and the intermediate cylinder to divide the first flow channel into first flow subdivisions;
a second flow channel defined between the intermediate cylinder and the outer cylinder, the second flow channel having second vanes each extending between and attached to the outer cylinder and the intermediate cylinder to divide the second flow channel into second flow subdivisions; and
an outlet diffuser attached to an outlet side of the particulate distributor, the outlet diffuser configured to reduce a cross-sectional area of each of the first flow subdivisions and the second flow subdivisions at the outlet side.

9. The particulate distributor of claim 8, wherein the outlet diffuser comprises:
a number of members, each member comprising:
opposed longitudinal edges extending radially in relation to the inner cylinder and having teeth formed in at least one of the opposed longitudinal edges; and
an impingement surface extending between the opposed longitudinal edges and into at least one adjacent first flow subdivision or adjacent second flow subdivision.

10. The particulate distributor of claim 9, wherein the opposed longitudinal edges each have the teeth formed therein and the impingement surface of a respective member extends into both adjacent first flow subdivisions or both adjacent second flow subdivisions.

11. The particulate distributor of claim 9, wherein the number of members equals a total of a number of the first vanes and a number of the second vanes.

12. The particulate distributor of claim 8, wherein the outer cylinder has an inlet diameter and an outlet diameter, the inlet diameter being greater than the outlet diameter.

13. The particulate distributor of claim 8, wherein the outer cylinder has a vertical portion having a first diameter and a flared portion extending from the vertical portion and having a second diameter at a distal end of the flared portion, the second diameter greater than the first diameter and positioned at an inlet side of the particulate distributor.

14. The particulate distributor of claim 8, wherein:
the first vanes are oriented to form a first angle with a longitudinal axis of the particulate distributor to direct flow in a first direction; and
the second vanes are oriented to form a second angle with the longitudinal axis of the particulate distributor to direct flow in a second direction.

15. A particulate distributor for pulverized coal flowing to a combustion chamber, the particulate distributor comprising:
an inner cylinder;
an outer cylinder concentric with the inner cylinder;
an intermediate cylinder concentric with the inner cylinder;
a first flow channel defined between the inner cylinder and the intermediate cylinder, the first flow channel having first vanes each extending between and attached to the inner cylinder and the intermediate cylinder;
a second flow channel defined between the intermediate cylinder and the outer cylinder, the second flow channel having second vanes each extending between and attached to the outer cylinder and the intermediate cylinder; and
an outlet diffuser attached at an outlet side of the particulate distributor, comprising:
a number of members, each member aligned with an outlet edge of a respective first vane or a respective second vane and comprising:
opposed longitudinal edges having teeth formed in therein, the teeth extending into one of the first flow channel or the second flow channel and forming an impingement surface configured to reduce a cross-sectional area of each of the first flow channel and the second flow channel.

16. The particulate distributor of claim 15, wherein the number of members equals a total of a number of the first vanes and a number of the second vanes.

17. The particulate distributor of claim 15, wherein the number of members is less than a total of a number of the first vanes and a number of the second vanes.

18. The particulate distributor of claim 15, wherein the outer cylinder has an inlet diameter and an outlet diameter, the inlet diameter being greater than the outlet diameter.

19. The particulate distributor of claim 15, wherein the outer cylinder has a vertical portion having a first diameter and a flared portion extending from the vertical portion and having a second diameter at a distal end of the flared portion, the second diameter greater than the first diameter and positioned at an inlet side of the particulate distributor.

20. The particulate distributor of claim 15, wherein:
the first vanes are oriented to form a first angle with a longitudinal axis of the particulate distributor to direct flow in a first direction; and
the second vanes are oriented to form a second angle with the longitudinal axis of the particulate distributor to direct flow in a second direction.
